(19) United States
(12) Patent Application Publication
(10) Pub. No.: US 2026/0205415 A1
(43) Pub. Date: Jul. 16, 2026

(54) NETWORK TRAFFIC LOAD BALANCING METHOD AND APPARATUS FOR DATA CENTER

(71) Applicant: Suzhou Metabrain Intelligent Technology Co., Ltd., Suzhou (CN)

(72) Inventors: Rengang LI, Suzhou (CN); Ruidong YAN, Suzhou (CN); Yaqian ZHAO, Suzhou (CN); Zhenhua GUO, Suzhou (CN); Lu LIU, Suzhou (CN); Liang JIN, Suzhou (CN); Cong XU, Suzhou (CN)

(73) Assignee: Suzhou Metabrain Intelligent Technology Co., Ltd., Suzhou (CN)

(21) Appl. No.: 18/714,043

(22) PCT Filed: Aug. 10, 2022
(86) PCT No.: PCT/CN2022/111378

§ 371 Date: May 28, 2024

(30) Foreign Application Priority Data
Apr. 18, 2022 (CN) 202210401272.7

(51) Int. Cl. H04L 47/125; H04L 41/0654; H04L 43/0882

(52) U.S. Cl. CPC H04L 47/125; H04L 41/0654; H04L 43/0882

(57) ABSTRACT

Disclosed are a network traffic load balancing method and apparatus for a data center, which are applied to the data center including a switch, a host, and a server. The method includes the following steps: collecting connection information between the switch, the host, and the server, and constructing a network topology structure of the data center according to the connection information; monitoring working information about each network link under the network topology structure, and correspondingly determining a congestion condition of each network link according to the working information about each network link; and allocating pre-transmitted data traffic packets to each network link according to the congestion condition to balance data traffic on each network link.

### CROSS-REFERENCE TO RELATED APPLICATION

The present application claims priority to Chinese Patent Application No. 202210401272.7, filed on Apr. 18, 2022 in China National Intellectual Property Administration and entitled “Network Traffic Load Balancing Method and Apparatus for Data Center”, which is hereby incorporated by reference in its entirety.

### FIELD

The present application relates to a network traffic load balancing method and apparatus for a data center.

### BACKGROUND

Currently, the data center plays a crucial role as the infrastructure for cloud computing platforms and distributed computing systems. The network traffic load balancing in the data center is an important prerequisite for ensuring system throughput and enhancing service quality. However, the inventors have recognized that, influenced by factors such as the network topology structure, transmission bandwidth, dynamic data traffic, and device faults, the data center often faces the issue of unbalanced network traffic load, which significantly hinders the efficiency and impacts service quality of the data center.

Therefore, devising a solution to the above technical problem is a current challenge that the skilled in the art must address.

### SUMMARY

By various embodiments disclosed herein, the present application provides a network traffic load balancing method and apparatus for a data center.

The present application relates to a network traffic load balancing method for a data center, which is applied to the data center containing a switch, a host, and a server, including:
collecting connection information between the switch, the host, and the server, and constructing a network topology structure of the data center according to the connection information;
monitoring working information about each network link under the network topology structure, and correspondingly determining a congestion condition of each network link according to the working information about each network link; and
allocating pre-transmitted data traffic packets to each network link according to the congestion condition to balance data traffic on each network link.

A network traffic load balancing apparatus for a data center is applied to the data center containing a switch, a host, and a server, including:
a network topology information collection module, configured to collect connection information between the switch, the host, and the server, and construct a network topology structure of the data center according to the connection information;
a link monitoring and congestion awareness module, configured to monitor working information about each network link under the network topology structure, and correspondingly determine a congestion condition of each network link according to the working information about each network link; and
a data traffic routing algorithm scheduling module, configured to allocate pre-transmitted data traffic packets to each network link according to the congestion condition to balance data traffic on each network link.

A network traffic load balancing apparatus for a data center includes:
a memory, configured to store computer-readable instructions; and
a processor, configured to implement steps of the network traffic load balancing method for a data center according to any of the above when executing computer-readable instructions.

One or more non-volatile computer-readable storage media store computer-readable instructions that, when executed by one or more processors, cause one or more processors to perform steps of the network traffic load balancing method for a data center according to any of the above.

### BRIEF DESCRIPTION OF THE DRAWINGS

To explain the technical solutions of the embodiments of the present application more clearly, a brief introduction will be made to the drawings used in the prior art and the embodiments. It is obvious that the drawings in the description below are only some embodiments of the present application, and those ordinarily skilled in the art can obtain other drawings according to these drawings without creative work.

FIG. 1 is a flow diagram of a network traffic load balancing method for a data center provided by one or more embodiments of the present application;

FIG. 2 is a workflow diagram of a network traffic load balancing system for a data center provided by one or more embodiments of the present application;

FIG. 3 is a structural diagram of a network traffic load balancing system for a data center provided by one or more embodiments of the present application;

FIG. 4 is a structural diagram of a network traffic load balancing apparatus for a data center provided by another one or more embodiments of the present application; and

FIG. 5 is a structural diagram of a computer-readable storage medium provided by one or more embodiments of the present application.

### DETAILED DESCRIPTION

The core of the present application is to provide a network traffic load balancing method and apparatus for a data center, which can be aware of the congestion condition of each network link of the data center, and control data traffic transmitted on each network link based on the congestion condition of each network link, thereby effectively improving the problem of unbalanced network traffic load existing in the data center, and improving the efficiency and service quality of the data center.

To make the object, technical solution, and advantages of the embodiments of the present application clearer, the technical solution in the embodiment of the present application is described clearly and completely in combination with the drawings in the embodiments of the present application. The described embodiments are a part of the embodiments of the present application, but not the whole embodiments. All other embodiments obtained by those ordinarily skilled in the art based on the embodiments in the present application without creative work shall fall within the scope of protection of the present application.

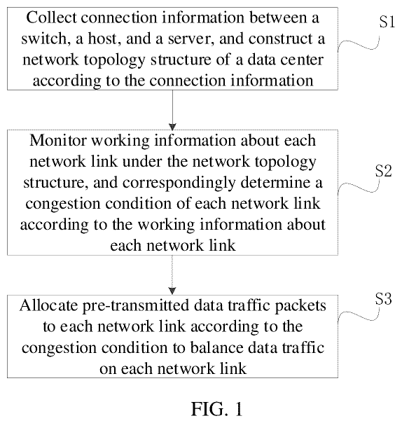

Referring to FIG. 1, FIG. 1 is a flow diagram of a network traffic load balancing method for a data center provided by embodiments of the present application.

The network traffic load balancing method for a data center is applied to the data center containing a switch, a host, and a server, including:

S1: Collect connection information between a switch, a host, and a server, and construct a network topology structure of a data center according to the connection information.

In some embodiments, the data center of the present application includes the switch, host (compute node), and server. The present application collects connection information between the switch, the host, and the server, and saves and records the connection information to construct a network topology structure of a data center according to the connection information between the switch, the host, and the server.

S2: Monitor working information about each network link under the network topology structure, and correspondingly determine a congestion condition of each network link according to the working information about each network link.

In some embodiments, the present application monitors working information about each network link under the network topology structure of the data center (a communication link between each device under the network topology structure of the data center), and analyzes the working information about each network link to correspondingly determine a congestion condition of each network link according to an analysis result of each network link, thereby providing a reference for subsequent data traffic scheduling.

S3: Allocate pre-transmitted data traffic packets to each network link according to the congestion condition to balance data traffic on each network link.

In some embodiments, according to the congestion condition of each network link under the network topology structure of the data center, the present application allocates pre-transmitted data traffic packets for each network link to enable data traffic of different network links to be in a relatively balanced state.

The present application might be aware of the congestion condition of each network link of the data center, and control data traffic transmitted on each network link based on the congestion condition of each network link, thereby effectively improving the problem of unbalanced network traffic load existing in the data center, and improving the efficiency and service quality of the data center.

### Based on the Above Embodiments

In one or more embodiments, the collecting connection information between a switch, a host, and a server includes:
broadcasting target information containing an Internet protocol (IP) address of a first device through the first device of the data center, and broadcasting the target information through a second device receiving the target information in the data center;
determining whether the first device receives the target information;
determining a bidirectional connection between the first device and the second device in response to the first device receiving the target information; and
determining a unidirectional connection between the first device and the second device in response to the first device not receiving the target information, communication directions between the two devices being directed from the first device to the second device,
the first device and the second device being any of the switches, the hosts, and the servers.

In some embodiments, the present application collects connection information between the switch, the host, and the server based on an information exchange mechanism. The process of the information exchange mechanism is as follows: broadcasting target information containing an IP address of a first device through the first device of the data center (the broadcasting means sending the target information to all the other devices of the data center), and broadcasting the target information through a second device receiving the target information in the data center; determining whether the first device receives the target information; determining a bidirectional connection between the first device and the second device in response to the first device receiving the target information, namely, there is information exchange between the first device and the second device; and determining a unidirectional connection between the first device and the second device in response to the first device not receiving the target information, communication directions between the two devices being directed from the first device to the second device.

For example, a host X broadcasts a piece of information x containing an IP address thereof, a host Y broadcasts the information x after receiving the information x, and if the host X receives the information x again, a bidirectional connection between the host X and the host Y is established; if the host X does not receive the information x, a unidirectional connection between the host X and the host Y is established, communication directions between the two hosts being directed from the host X to the host Y.

In one or more embodiments, after the constructing a network topology structure of the data center according to the connection information and before the monitoring working information about each network link under the network topology structure, the network traffic load balancing method for a data center further includes:
detecting a fault condition of each device in the data center to determine a fault device in the data center; and
deleting a network topology structure corresponding to the fault device in the network topology structure to obtain a reconstructed network topology structure.

Furthermore, after constructing a network topology structure of a data center according to the connection information between the switch, the host, and the server, the present application first detects a fault condition of each device in the data center to determine a fault device in the data center and then deletes a network topology structure corresponding to the fault device in the network topology structure of the data center to obtain a reconstructed network topology structure, to monitor working information about each network link under the reconstructed network topology structure.

In one or more embodiments, the detecting a fault condition of each device in the data center to determine a fault device in the data center includes:
sending, through each sending device in the data center, a pre-set amount of information to a receiving device corresponding to each sending device; and
counting an information sending success rate of each sending device, and determining a receiving device corresponding to a lowest information sending success rate as the fault device.

In some embodiments, the specific method of the device fault detection of the present application is an information sending success rate ranking mechanism. Before introducing the method, the definition of information sending success is given first: A normal device A sends information to a device B, the device B receives the information and sends confirmation information to the device A, and if the device A receives the confirmation information, the device A is considered to complete information sending success to the device B once; if the device A does not receive the confirmation information from the device B, the device B is considered to be faulty.

The process of the information sending success rate ranking mechanism is as follows: sending a pre-set amount of information to each receiving device corresponding to each sending device via each sending device in the data center; then counting the information sending success times of each sending device; correspondingly calculating the information sending success rate of each sending device based on the information sending success times of each sending device; and determining the receiving device corresponding to the lowest information sending success rate as the fault device.

For example, it is assumed that in the data center, device A sends information to device B, device C sends information to device D, and device E sends information to device F. n times of information is sent from device A to device B, from device C to the device D, and from the device E to the device F. The information sending success times of devices A, C, and E count as m1, m2, and m3, respectively. The information sending success rates of devices A, C, and E are m1/n, m2/n, and/m3/n, respectively. The above information sending success rates are arranged in descending order, and a receiving device corresponding to the lowest information sending success rate is determined as the fault device.

In one or more embodiments, the monitoring working information about each network link under the network topology structure, and correspondingly determining a congestion condition of each network link according to the working information about each network link includes:
monitoring bandwidth utilization of each network link between a target sending end and a target receiving end under the network topology structure, and calculating a link bandwidth average utilization between the target sending end and the target receiving end according to the bandwidth utilization of each network link;
determining whether bandwidth utilization of a target network link is greater than or equal to the link bandwidth average utilization, where the target network link is any network link between the target sending end and the target receiving end;
determining the target network link to be congested in response to the bandwidth utilization of the target network link being greater than or equal to the link bandwidth average utilization; and
determining the target network link to be non-congested in response to the bandwidth utilization of the target network link being less than the link bandwidth average utilization.

In some embodiments, the congestion awareness principle of each network link under the network topology structure of the data center is as follows: monitoring the bandwidth utilization of each network link between the target sending end and the target receiving end under the network topology structure, and summing the bandwidth utilization of each network link between the target sending end and the target receiving end to obtain the total bandwidth utilization of each network link between the target sending end and the target receiving end; dividing the total bandwidth utilization by the total number of network links between the target sending end and the target receiving end to obtain the link bandwidth average utilization between the target sending end and the target receiving end; then determining whether the bandwidth utilization of any network link (referred to as a target network link) between the target sending end and the target receiving end is greater than or equal to the link bandwidth average utilization; determining the target network link to be congested (traffic overload) in response to being greater than or equal to the link bandwidth average utilization; determining the target network link to be non-congested (lightly loaded) in response to being less than the link bandwidth average utilization.

For example, if there are a total of m network links between the sending end A and the receiving end B, and the bandwidth utilization of the m network links are U₁, . . . , Uₘ, respectively, then the link bandwidth average utilization between the sending end A and the receiving end B is

$$\overline{U} = \frac{1}{n} {\sum }_{i = 1}^{n} {U}_{i} .$$

If the bandwidth utilization of a certain network link between the sending end A and the receiving end B is greater than or equal to the link bandwidth average utilization Ū, the network link is marked as traffic overload; otherwise, the network link is marked as lightly loaded.

In one or more embodiments, the monitoring bandwidth utilization of each network link between a target sending end and a target receiving end under the network topology structure includes:
acquiring a sending data amount, a receiving data amount, and a duration between sending data and receiving data of all communication ports under the network topology structure every pre-set time;
calculating the current port rate of each communication port according to SU=[(SI₂+AI₂)−(SI₁+AI₁)]/(T₂−T₁), where SU is the current port rate of a target communication port; SI₁ and SI₂ are sending data amounts of the target communication port acquired successively in the last two times, respectively; AI₁ and AI₂ are receiving data amounts of the target communication port acquired successively in the last two times, respectively; T₁ and T₂ are durations of the target communication port acquired successively in the last two times, respectively;
taking a smaller value of the current port rates of two communication ports connected at two ends of the target network link as a current used bandwidth of the target network link; and
dividing the current used bandwidth of the target network link by an inherent bandwidth of the target network link to obtain a current bandwidth utilization of the target network link.

In some embodiments, the calculation principle of link bandwidth utilization: link bandwidth utilization (U)=link used bandwidth/link inherent bandwidth.

The calculation principle of the used bandwidth of the link is as follows: step 1, sending a status request message to the switch at intervals to acquire the sending data amount (the number of bytes) Send_Imformation (SI), the receiving data amount Accept_Imformation (AI), and the duration Time (T) between the sending data and the receiving data of all communication ports under the network topology structure of the data center through the switch; step 2, communication port rate being Seep_Up (SU)=[(SI₂+AI₂)−(SI₁+AI₁)]/(T₂−T₁); step 3, based on communication port rate calculation formula, the used bandwidth Band_Width (BW) of link A->B is calculated as follows: first, calculating the port rate SUA of the communication port A and the port rate SUB of the communication port B; second, comparing the two, and selecting the smaller of the two as the used bandwidth of link A->B, that is, BW=min (SUA, SUB).

In one or more embodiments, the allocating pre-transmitted data traffic packets to each network link according to the congestion condition includes:
determining whether pre-transmitted data traffic packets from the target sending end to the target receiving end under the network topology structure need to be split according to a pre-set data packet splitting strategy;
splitting, based on available bandwidths of non-congested network links between the target sending end and the target receiving end, the data traffic packets in response to the data traffic packets needing to be split, and selecting suitable non-congested network links for transmission for the split sub-data traffic packets, whereby the target receiving end obtains the data traffic packets transmitted by the target sending end by assembling the sub-data traffic packets; and
selecting any network link from the non-congested network links between the target sending end and the target receiving end to transmit the data traffic packets in response to the data traffic packets not needing to be split, whereby the target receiving end receives the data traffic packets transmitted by the target sending end.

In some embodiments, the process of allocating pre-transmitted data traffic packets for each network link under a network topology structure of the data center in the present application includes: determining whether pre-transmitted data traffic packets from the target sending end to the target receiving end under the network topology structure of the data center need to be split according to a pre-set data packet splitting strategy; splitting, based on available bandwidths of non-congested network links between the target sending end and the target receiving end, the data traffic packets in response to the data traffic packets needing to be split to obtain a plurality of sub-data traffic packets, performing sequence marking on the plurality of sub-data traffic packets, and selecting suitable non-congested network links for transmission for the sub-data traffic packets, whereby the target receiving end obtains the data traffic packets transmitted by the target sending end by assembling the received sub-data traffic packets; and in some embodiments assembling and recovering the actually transmitted data traffic packets from the target sending end to the target receiving end according to the markers of the sub-data traffic packets; selecting any network link from the non-congested network links between the target sending end and the target receiving end to transmit the data traffic packets in response to the data traffic packets not needing to be split, whereby the target receiving end receives the data traffic packets transmitted by the target sending end.

In one or more embodiments, the determining whether pre-transmitted data traffic packets from the target sending end to the target receiving end under the network topology structure need to be split according to a pre-set data packet splitting strategy includes:
acquiring communication delays of the data traffic packets passing through each network link between the target sending end and the target receiving end, and taking a minimum value of the communication delays on each network link as a splitting threshold;
determining whether transmission requirement delays of the data traffic packets are less than the splitting threshold;
determining that the data traffic packets need to be split in response to the transmission requirement delays of the data traffic packets being less than the splitting threshold; and
determining that the data traffic packets do not need to be split in response to the transmission requirement delays of the data traffic packets being not less than the splitting threshold.

In some embodiments, the data packet splitting strategy of the present application is: acquiring communication delays of the data traffic packets passing through each network link between the target sending end and the target receiving end, and taking a minimum value of the communication delays on each network link as a splitting threshold; determining whether transmission requirement delays of the data traffic packets are less than the splitting threshold; determining that the data traffic packets need to be split in response to the transmission requirement delays of the data traffic packets being less than the splitting threshold; and determining that the data traffic packets do not need to be split in response to the transmission requirement delays of the data traffic packets being not less than the splitting threshold.

For example, if there are m network links between the sending end A and the receiving end B, the communication delays D₁, D₂, . . . , Dₘ of the data traffic packets currently to be transmitted passing through each network link between the sending end A and the receiving end B are calculated. The minimum value of the network link communication delays is selected as the Split_Threshold (ST), that is, ST-min (D₁, D₂, . . . , Dₘ). The data traffic packets need to be split in response to the transmission requirement delays of the data traffic packets being less than the ST; otherwise, the data traffic packets do not need to be split.

In one or more embodiments, the acquiring communication delays of the data traffic packets passing through each network link between the target sending end and the target receiving end includes:
dividing a total size of the data traffic packets by an available bandwidth of a target network link to obtain sending delays of the data traffic packets passing through the target network link, where the target network link is any network link between the target sending end and the target receiving end;
dividing a length of the target network link by an electromagnetic wave propagation rate to obtain propagation delays of the data traffic packets passing through the target network link;
summing splitting delays, assembling delays, and queuing delays of the data traffic packets to obtain processing delays of the data traffic packets passing through the target network link; and
summing the sending delays, the propagation delays, and the processing delays to obtain communication delays of the data traffic packets passing through the target network link.

In some embodiments, the calculation principle of the link communication delays are as follows: the communication delay (D) represents the total time required for a data traffic packet to be transmitted from a sending end to a receiving end, which is composed of three parts: sending delay, propagation delay, and processing delay, namely, total communication delay=sending delay+propagation delay+processing delay; the Send_Delay (SD)-total size of the data traffic packet/the link available bandwidth, and the link available bandwidth (AB)=the link inherent bandwidth-the link used bandwidth; Propagation_Delay (PD)-link length/electromagnetic wave propagation rate; processing delay, for example, Other_Delay (OD)=data traffic packet splitting delay+data traffic packet assembling delay+data traffic packet queuing delay.

In one or more embodiments, the splitting, based on available bandwidths of non-congested network links between the target sending end and the target receiving end, the data traffic packets, and selecting suitable non-congested network links for transmission for the split sub-data traffic packets includes:
summing available bandwidths of all non-congested network links between the target sending end and the target receiving end to obtain a total available bandwidth between the target sending end and the target receiving end;
dividing an available bandwidth of a target non-congested network link by the total available bandwidth to obtain an available bandwidth proportion of the target non-congested network link, where the target non-congested network link is any non-congested network link between the target sending end and the target receiving end;
multiplying the available bandwidth proportion of the target non-congested network link by the total size of the data traffic packets to obtain sizes of pre-transmitted sub-data traffic packets on the target non-congested network link; and
splitting the data traffic packets according to the sizes of pre-transmitted sub-data traffic packets on all the non-congested network links, and selecting the suitable non-congested network links for transmission for the split sub-data traffic packets.

In some embodiments, the present application provides three data packet splitting methods (taking a sending end A, a receiving end B and m network links existing between the sending end A and the receiving end B as an example to explain):

Firstly, the equivalent splitting method is to split the original data traffic packet into several sub-data traffic packets with the same size, and then allocate these sub-data traffic packets to m network links between the sending end A and the receiving end B. The advantages of this method are simple operation and low overhead. However, the optimal number of split sub-data traffic packets is not easily determined.

Secondly, the link average splitting method is to split the original data traffic packet according to the number of m network links between the sending end A and the receiving end B. The traffic of each split sub-data traffic packet is the same. For example, if a data traffic packet with a size of 100 G is to be transmitted from a sending end A to a receiving end B, and m links exist between the sending end A and the receiving end B, the data traffic packet might be split into m sub-data traffic packets with a size of 100 G/m.

Third, the link available bandwidth proportion splitting method is to split the original data traffic packet according to the number of m network links between the sending end A and the receiving end B and the link available bandwidths; the size of a sub-data traffic packet transmitted by each network link is positively correlated with the size of the available bandwidth of the network link. For example, if the data traffic packet with a size of 100 G is to be transmitted from the sending end A to the receiving end B, there are m links between the sending end A and the receiving end B, and each link available bandwidth is AB₁, AB₂, . . . , ABₘ, then the data traffic packet is split into m sub-data traffic packets, and the size of each sub-data traffic packet is calculated according to the proportion

$$( \frac{A {B}_{1}}{{\sum }_{i = 1}^{m} {AB}_{i}} ) * 100 G , ( \frac{A {B}_{2}}{{\sum }_{i = 1}^{m} {AB}_{i}} ) * 100 G , … , ( \frac{A {B}_{m}}{{\sum }_{i = 1}^{m} {AB}_{i}} ) * 100 G .$$

For all non-congested network links between the target sending end and the target receiving end, the present application uses the link available bandwidth proportion splitting method to transmit the data traffic packets; summing available bandwidths of all non-congested network links between the target sending end and the target receiving end to obtain a total available bandwidth between the target sending end and the target receiving end; dividing the available bandwidth of any non-congested network link between the target sending end and the target receiving end (referred to as a target non-congested network link) by the total available bandwidth to obtain an available bandwidth proportion of the target non-congested network link; multiplying the available bandwidth proportion of the target non-congested network link by the total size of the data traffic packets to obtain sizes of pre-transmitted sub-data traffic packets on the target non-congested network link, thereby obtaining the sizes of the pre-transmitted sub-data traffic packets on all the non-congested network links between the target sending end and the target receiving end.

Based on this, the present application splits a data traffic packet to be transmitted according to the sizes of the pre-transmitted sub-data traffic packets on all non-congested network links between the target sending end and the target receiving end and selects the suitable non-congested network links for transmission for the split sub-data traffic packets.

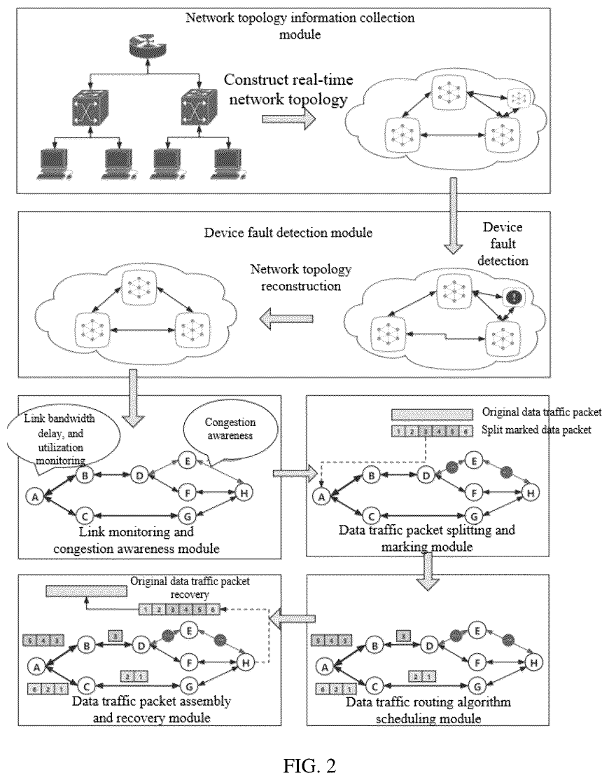

In addition, the present application further provides a network traffic load balancing system for a data center; the system includes six modules, namely, a network topology information collection module, a device fault detection module, a link monitoring and congestion awareness module, a data traffic packet splitting and marking module, a data routing algorithm scheduling module, and a data traffic packet assembly and recovery module. The logical relationship between modules is shown in FIG. 2:
(1) The network topology information collection module is mainly configured to collect connection information between the switch, the host, and the server, and construct a network topology structure of the data center according to the connection information.
(2) The device fault detection module is mainly configured to detect the fault condition of each device in the data center to determine the fault device in the data center; delete a network topology structure corresponding to the fault device in the network topology structure constructed by the network topology information collection module to obtain a reconstructed network topology structure.
(4) The link monitoring and congestion awareness module includes two sub-modules, namely, a link monitoring module and a congestion awareness module. Based on the reconstructed network topology structure saved by the network topology information collection module and the device fault detection module, the link monitoring module first monitors the communication used/available bandwidth, communication delay, and link bandwidth utilization of each network link under the network topology structure in real-time. Then, the congestion awareness module is mainly configured to be aware of the congestion condition of each network link under the network topology structure in real-time and quantify the congestion degree of each network link, to provide a reference for subsequent data traffic scheduling.
(4) The data traffic packet splitting and marking module includes two sub-modules, namely, a data packet splitting module and a sub-data packet marking module. The data packet splitting module first splits the original larger data traffic packet into several sub-data traffic packets. The sub-data packet traffic marking module performs sequence marking on the split sub-data traffic packets, to facilitate subsequent module scheduling.
(5) The data traffic routing algorithm scheduling module is mainly configured to allocate pre-transmitted data traffic packets for each network link according to the congestion condition of each network link to balance the data traffic on each network link, that is, based on the current network topology structure saved in real-time and the split sub-data traffic packets, design a mapping rule between each sub-data traffic packet and different network links, and provide a data traffic packet routing method, whereby the data traffic of different network links is in a relatively balanced state.
(6) The data traffic packet assembly and recovery module is mainly configured to assemble and recover the sub-data traffic packets received by the receiving end according to the pre-calibrated order based on the results of the data traffic routing algorithm scheduling module and the sub-data packet marking module and provide the final data traffic packet scheduling results.

Reference is made to the embodiments of the load balancing method described above for a detailed description of the load balancing system provided herein, which will not be described in detail herein.

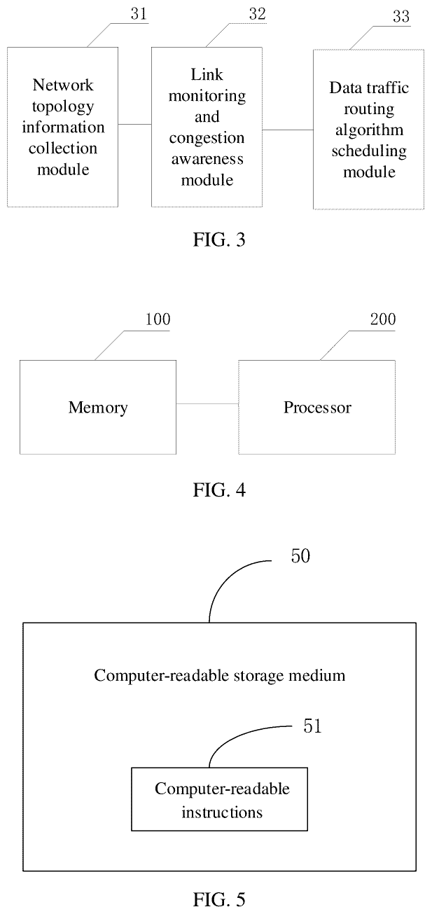

In one or more embodiments, referring to FIG. 3, the present application further provides a network traffic load balancing apparatus for a data center, which is applied to the data center containing a switch, a host, and a server, and may include a network topology information collection module 31, a link monitoring and congestion awareness module 32, and a data traffic routing algorithm scheduling module 33.

The network topology information collection module 31 is configured to collect connection information between the switch, the host, and the server, and construct a network topology structure of the data center according to the connection information.

The link monitoring and congestion awareness module 32 is configured to monitor working information about each network link under the network topology structure, and correspondingly determine the congestion condition of each network link according to the working information about each network link.

The data traffic routing algorithm scheduling module 33 is configured to allocate pre-transmitted data traffic packets to each network link according to the congestion condition to balance data traffic on each network link.

For the specific definition of the network traffic load balancing apparatus for a data center, reference might be made to the above definition of a network traffic load balancing method for the data center, and the description thereof will not be repeated here. The various modules in the network traffic load balancing apparatus for the data center described above may be implemented in whole or in part by software, hardware, and combinations thereof. The modules might be embedded in the hardware form or independent of the processor in the computer device or might be stored in the software form in the memory of the computer device, whereby the processor schedules to perform the operations corresponding to the above modules.

Referring to FIG. 4, FIG. 4 is a structural diagram of a network traffic load balancing apparatus for a data center provided by an embodiment of the present application.

The network traffic load balancing apparatus for a data center includes:
a memory 100, configured to store computer-readable instructions; and
a processor 200, configured to implement steps of the network traffic load balancing method for a data center of any of the above embodiments when executing computer-readable instructions.

In one or more embodiments, referring to FIG. 5, the present application further provides a computer-readable storage medium 50 that stores computer-readable instructions 51; the computer-readable instructions 51, when executed by one or more processors, cause the one or more processors to perform steps of the network traffic load balancing method for a data center of any one of the above embodiments.

It will be appreciated by the ordinarily skilled in the art that implementing all or part of the flow of the methods of the above embodiments may be accomplished by instructing the associated hardware by computer programs, which may be stored on a non-volatile computer-readable storage medium; the programs, when executed, may include the flow of the embodiments of the above methods. Any references to memory, storage, databases, or other media used in the embodiments provided by the present application may include a non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include random-access memory (RAM) or external cache. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), synchlink DRAM (SLDRAM), Rambus DRAM (RDRAM), direct Rambus DRAM (DRDRAM).

Reference is made to the embodiments of the load balancing method described above for a detailed description of the load balancing apparatus provided herein, which will not be described in detail herein.

It should also be noted that the use of relational terms such as first and second, and the like in the specification are used solely to distinguish one entity or operation from another entity or operation without necessarily requiring or implying any actual such relationship or order between such entities or operations. Moreover, the terms “include/include”, “contain”, or any other variation thereof, are intended to cover a non-exclusive inclusion, such that a process, method, article, or device that includes a list of elements does not include only those elements but may include other elements not expressly listed or inherent to such process, method, article, or device. An element proceeded by “include/include a . . . ” does not, without more constraints, preclude the existence of additional identical elements in the process, method, article, or device that includes the element.

The previous description of the disclosed embodiments is provided to enable the skilled in the art to make or use the present application. Various modifications to these embodiments will be readily apparent to the skilled in the art, and the generic principles defined herein may be implemented in other embodiments without departing from the spirit or scope of the present application. Therefore, the present application will not be limited to these embodiments shown herein but will conform to the broadest scope consistent with the principles and novel features disclosed herein.

1. A network traffic load balancing method for a data center, being applied to the data center containing a switch, a host, and a server, comprising:
collecting connection information between the switch, the host, and the server, and constructing a network topology structure of the data center according to the connection information;
monitoring working information about each of network links under the network topology structure, and correspondingly determining a congestion condition of each of the network links according to the working information about each of the network links; and
allocating pre-transmitted data traffic packets to each of the network links according to the congestion condition to balance data traffic on each of the network links.

2. The method according to claim 1, wherein the collecting connection information between the switch, the host, and the server comprises:
broadcasting target information containing an Internet protocol (IP) address of a first device through the first device of the data center, and broadcasting the target information through a second device receiving the target information in the data center;
determining whether the first device receives the target information; and
determining a bidirectional connection between the first device and the second device in response to the first device receiving the target information, wherein the first device and the second device are any of the switches, the hosts, and the servers.

3. The method according to claim 2, further comprising:
determining a unidirectional connection between the first device and the second device in response to the first device not receiving the target information, and a communication direction between the first device and the second device being directed from the first device to the second device.

4. The method according to claim 1, characterized wherein after the constructing a network topology structure of the data center according to the connection information and before the monitoring working information about each network link under the network topology structure, the method further comprises:
detecting a fault condition of each of devices in the data center to determine a fault device in the data center; and
deleting a network topology structure corresponding to the fault device in the network topology structure to obtain a reconstructed network topology structure.

5. The method according to claim 4, wherein the detecting a fault condition of each of devices in the data center to determine a fault device in the data center comprises:
sending, through each of sending devices of the devices in the data center, a pre-set amount of information to each of receiving devices of the devices corresponding to each of the sending devices; and
counting an information sending success rate of each of the sending devices, and determining a receiving device of the receiving devices which has a lowest information sending success rate as the fault device.

6. The method according to claim 1, wherein the monitoring working information about each of network links under the network topology structure, and correspondingly determining a congestion condition of each of the network links according to the working information about each of the network links comprises:
monitoring bandwidth utilization of each of the network links between target sending ends and target receiving ends under the network topology structure, and calculating a link bandwidth average utilization between the target sending ends and the target receiving ends according to the bandwidth utilization of each of the network links;
determining whether bandwidth utilization of a target network link is greater than or equal to the link bandwidth average utilization, wherein the target network link is any network link of the links between the target sending ends and the target receiving ends; and
determining the target network link to be congested in response to the bandwidth utilization of the target network link being greater than or equal to the link bandwidth average utilization.

7. The method according to claim 6, further comprising:
determining the target network link to be non-congested in response to the bandwidth utilization of the target network link being less than the link bandwidth average utilization.

8. The method according to claim 6, wherein the monitoring bandwidth utilization of each of the network links between target sending ends and target receiving ends under the network topology structure comprises:
acquiring a sending data amount, a receiving data amount, and a duration between sending data and receiving data of communication ports under the network topology structure every pre-set time;
calculating a current port rate of each of the communication ports according to the sending data amount, the receiving data amount, and the duration between the sending data and the receiving data of each of the communication ports acquired successively in the last two times;
taking a smaller value of the current port rates of two communication ports connected at two ends of the target network link as a current used bandwidth of the target network link; and
dividing the current used bandwidth of the target network link by an inherent bandwidth of the target network link to obtain a current bandwidth utilization of the target network link.

9. The method according to claim 8, wherein the calculating a current port rate of each of the communication ports according to the sending data amount, the receiving data amount, and the duration between the sending data and the receiving data of each of the communication ports acquired successively in the last two times comprises:
calculating the current port rate of each of the communication ports according to SU=[(SI₂+AI₂)−(SI₁+AI₁)]/(T₂−T₁), wherein SU is a current port rate of a target communication port of the communication ports; SI₁ and SI₂ are sending data amounts of the target communication port acquired successively in the last two times, respectively; AI₁ and AI₂ are receiving data amounts of the target communication port acquired successively in the last two times, respectively; T₁ and T₂ are durations of the target communication port acquired successively in the last two times, respectively.

10. The method according to claim 6, wherein the allocating pre-transmitted data traffic packets to each of the network links according to the congestion condition comprises:
determining whether the pre-transmitted data traffic packets from a target sending end of the target sending ends to a target receiving end of the target receiving ends under the network topology structure need to be split according to a pre-set data packet splitting strategy; and
splitting the data traffic packets into a plurality of sub-data traffic packets with a same size in response to the pre-transmitted data traffic packets from the target sending end to the target receiving end under the network topology structure needing to be split, and selecting suitable non-congested network links for transmission for the split sub-data traffic packets, whereby the target receiving end obtains the pre-transmitted data traffic packets transmitted by the target sending end by assembling the sub-data traffic packets.

11. The method according to claim 1, wherein the allocating pre-transmitted data traffic packets to each of the network links according to the congestion condition comprises:
determining whether the pre-transmitted data traffic packets from the target sending end to the target receiving end under the network topology structure need to be split according to a pre-set data packet splitting strategy; and
splitting, according to a number of network links between the target sending end and the target receiving end, the pre-transmitted data traffic packets into sub-data traffic packets equal to the number and with a same size in response to the pre-transmitted data traffic packets from the target sending end to the target receiving end under the network topology structure needing to be split, and selecting suitable non-congested network links for transmission for the split sub-data traffic packets, whereby the target receiving end obtains the pre-transmitted data traffic packets transmitted by the target sending end by assembling the sub-data traffic packets.

12. The method according to any one of claim 6, wherein the allocating pre-transmitted data traffic packets to each of the network links according to the congestion condition comprises:
determining whether the pre-transmitted data traffic packets from the target sending end to the target receiving end under the network topology structure need to be split according to a pre-set data packet splitting strategy; and
splitting, based on available bandwidths of non-congested network links between the target sending end and the target receiving end, the pre-transmitted data traffic packets in response to the pre-transmitted data traffic packets from the target sending end to the target receiving end under the network topology structure needing to be split, and selecting suitable non-congested network links for transmission for the split sub-data traffic packets, whereby the target receiving end obtains the pre-transmitted data traffic packets transmitted by the target sending end by assembling the sub-data traffic packets.

13. The method according to claim 10, further comprising:
selecting any one non-congested network link from the suitable non-congested network links between the target sending end and the target receiving end to transmit the pre-transmitted data traffic packets in response to the pre-transmitted data traffic packets from the target sending end to the target receiving end under the network topology structure not needing to be split, whereby the target receiving end receives the pre-transmitted data traffic packets transmitted by the target sending end.

14. The method according to claim 10, wherein the determining whether pre-transmitted data traffic packets from the target sending end to the target receiving end under the network topology structure need to be split according to a pre-set data packet splitting strategy comprises:
acquiring communication delays of the pre-transmitted data traffic packets passing through each of the network links between the target sending end and the target receiving end, and taking a minimum value of the communication delays on each of the network links as a splitting threshold;
determining whether a transmission requirement delay of the pre-transmitted data traffic packets is less than the splitting threshold; and
determining that the pre-transmitted data traffic packets need to be split in response to the transmission requirement delay of the pre-transmitted data traffic packets being less than the splitting threshold.

15. The method according to claim 14, further comprising:
determining that the pre-transmitted data traffic packets do not need to be split in response to the transmission requirement delay of the pre-transmitted data traffic packets being not less than the splitting threshold.

16. The method according to claim 14, wherein the acquiring communication delays of the pre-transmitted data traffic packets passing through each of the network links between the target sending end and the target receiving end comprises:
dividing a total size of the pre-transmitted data traffic packets by an available bandwidth of the target network link to obtain sending delays of the pre-transmitted data traffic packets passing through the target network link, wherein the target network link is any one of the network links between the target sending end and the target receiving end;
dividing a length of the target network link by an electromagnetic wave propagation rate to obtain propagation delays of the pre-transmitted data traffic packets passing through the target network link;
summing splitting delays, assembling delays, and queuing delays of the pre-transmitted data traffic packets to obtain processing delays of the pre-transmitted data traffic packets passing through the target network link; and
summing the sending delays, the propagation delays, and the processing delays to obtain the communication delays of the pre-transmitted data traffic packets passing through the target network link.

17. The method according to claim 12, wherein the splitting, based on available bandwidths of non-congested network links between the target sending end and the target receiving end, the pre-transmitted data traffic packets, and selecting suitable non-congested network links for transmission for the split sub-data traffic packets comprises:
summing the available bandwidths of non-congested network links between the target sending end and the target receiving end to obtain a total available bandwidth between the target sending end and the target receiving end;
dividing an available bandwidth of a target non-congested network link of the non-congested network links by the total available bandwidth to obtain an available bandwidth proportion of the target non-congested network link, wherein the target non-congested network link is any one of the non-congested network links between the target sending end and the target receiving end;
multiplying the available bandwidth proportion of the target non-congested network link by a total size of the pre-transmitted data traffic packets to obtain sizes of pre-transmitted sub-data traffic packets on the target non-congested network link; and
splitting the pre-transmitted data traffic packets according to the sizes of the pre-transmitted sub-data traffic packets on the non-congested network links, and selecting the suitable non-congested network links for transmission for split sub-data traffic packets of the pre-transmitted data traffic packets.

18. (canceled)

19. A network traffic load balancing apparatus for a data center, comprising:
a memory storing computer-readable instructions; and
a processor configured to execute the computer readable instructions, wherein upon execution of the computer readable instructions, the processor is configured to:
collect connection information between a switch, a host, and a server, and construct a network topology structure of the data center according to the connection information;
monitor working information about each of network links under the network topology structure, and correspondingly determine a congestion condition of each of the network links according to the working information about each of the network links; and
allocate pre-transmitted data traffic packets to each of the network links according to the congestion condition to balance data traffic on each of the network links.

20. One or more non-volatile computer-readable storage media storing therein computer-readable instructions, wherein the computer-readable instructions, upon execution by one or more processors, are configured to cause the one or more processors to:
monitor working information about each of network links under a network topology structure, and correspondingly determine a congestion condition of each of the network links according to the working information about each of the network links; and
allocate pre-transmitted data traffic packets to each of the network links according to the congestion condition to balance data traffic on each of the network links.

21. The method according to claim 10, further comprising:
performing sequence marking on the plurality of sub-data traffic packets, whereby the target receiving end assembles the plurality of sub-data traffic packets according to markers of the plurality of sub-data traffic packets in order to recover the pre-transmitted data traffic packets.
